(19) United States
(12) Patent Application Publication
(10) Pub. No.: US 2016/0033919 A1
(43) Pub. Date: Feb. 4, 2016

(54) IMAGE FORMING APPARATUS

(71) Applicant: KYOCERA Document Solutions Inc., Osaka (JP)

(72) Inventor: Makoto EGI, Osaka-shi (JP)

(73) Assignee: KYOCERA DOCUMENT SOLUTIONS INC., Osaka (JP)

(21) Appl. No.: 14/816,790

(22) Filed: Aug. 3, 2015

(30) Foreign Application Priority Data
Aug. 4, 2014 (JP) 2014-158441
Aug. 11, 2014 (JP) 2014-163415

(51) Int. Cl. G03G 15/00

(52) U.S. Cl. CPC G03G 15/6529

(57) ABSTRACT

An image forming apparatus includes a guiding part, a discharge flow path and an airflow control mechanism. The guiding part is configured to form a sheet conveying path from a sheet feeding part to a transferring device between a development unit and the transferring device. The discharge flow path formed between the development unit and the guiding part communicates with a sheet feeding part-side space where the sheet conveying path faces the sheet feeding part and an image carrier-side space where the sheet conveying path faces the image carrier. The airflow control mechanism is configured to guide airflow generated in the sheet feeding part-side space when a rear end of the sheet is separated from the sheet feeding part in a direction spaced away from a developing nip.

### INCORPORATION BY REFERENCE

This application is based on and claims the benefit of priorities from Japanese Patent application No. 2014-158441 filed on Aug. 4, 2014 and Japanese Patent application No. 2014-163415 filed on Aug. 11, 2014, the entire contents of which are incorporated herein by reference.

### BACKGROUND

The present disclosure relates to an image forming apparatus configured to form a toner image on an image carrier and then transfer this tonner image into a sheet to form an image.

### SUMMARY

In an electro-photographic type image forming apparatus, such as a copying machine, a printer, a facsimile or a multifunctional peripheral, an electrostatic latent image formed on an image carrier is developed with a toner by a development unit to forma toner image and then the toner image is transferred from the image carrier into a sheet by a transferring device. If a flow of air is generated due to behavior of the sheet in a space between the development unit and the transferring device, there may be a case in which image quality is degraded by this flow of air.

With reference to FIGS. 13A to 15, the flow of air due to the behavior of the sheet will be described. As shown in FIG. 13A, a sheet P passes through a resist rollers pair 101, is conveyed along a guiding part 102 and then enters a transferring nip 105 formed between an image carrier 103 and a transferring roller 104. And, at the transferring nip 105, a toner image is transferred from the image carrier 103 into the sheet P.

The sheet P to which the toner image has been transferred is conveyed to a fixing device. When a rear end of the sheet P is spaced away from an outlet of the resist rollers pair 101 (refer to the double-dotted chain line of FIG. 13A), the rear end is elastically rebounded leftward of FIG. 13A (refer the solid line of FIG. 13A) and then hits a guiding plate forming the guiding part 102. Then, an airflow F101 is generated so as to flow from a space S101 on an inlet side of the guiding part 102 through a space S102 between the guiding part 102 and the resist rollers pair 101 and a space S103 between the guiding part 102 and a development unit 106 toward the image carrier 103. This airflow F101 affects forming of the toner image in the developing nip 107 formed between the image carrier 103 and the development unit 106, and degrades image quality. Specifically, as shown in FIG. 13B, when a grey image G is printed, a lateral stripe L is generated on a rear end portion of the sheet P.

In order to prevent generation of the airflow F101, as shown in FIG. 14, a method for closing the space S102 between the resist rollers pair 101 and the guiding part 102 by a wind shielding member 110 is considered. By providing such a wind shielding member 110, since the airflow F101 toward the space S103 between the guiding part 102 and the development unit 106 is shielded, the generation of the lateral stripe L on the rear end portion of the grey image G is prevented. However, if the wind shielding member 110 is provided in the space S102, there occurs a problem that an abnormal noise is generated or that sheet powder is accumulated on the wind shielding member 110.

Furthermore, an airflow F102 (refer to FIG. 13A) flowing from a gap between a left face of the sheet P and an inner face of the guiding part 102 toward the image carrier 103 is generated while the sheet P is conveyed through the guiding part 102. This airflow F102 may also affect the toner image formed on the image carrier 103.

Alternatively, as shown in FIG. 15A, it is considered that the space S103 between the development unit 106 and the guiding part 102 is closed by the wind shielding member 111. However, if the wind shielding member 111 is provided in the space S103, the following problem occurs. Namely, when a leading end of the sheet P that is conveyed through the guiding part 102 hits the surface of the image carrier 103, as shown in FIG. 15A, an airflow F103 flowing from the space S104 on an outlet side of the guiding part 102 toward the developing nip 107 is generated. Although this airflow F103 usually flows into the space S103 between the guiding part 102 and the development unit 106 without flowing toward the developing nip 107, if the space S103 is closed by the wind shielding member 111, the airflow F103 has no way out and then flows toward the developing nip 107. In this manner, as shown in FIG. 15B, when the grey image G is printed, degradation of image quality such that the lateral stripe L is generated at a front end portion of the sheet P occurs.

As an image forming apparatus considering airflow near the image carrier, there is an image forming apparatus configured to prevent toner scattering due to the airflow along the surface of an image carrier generated by rotation of the image carrier. In this image forming apparatus, an airflow passing through a gap between a guiding part and a sheet feeding part is formed and a part of an airflow along the surface of the image carrier is joined with the thus formed air flow, whereby the airflow along the surface of the image carrier turns in a direction spaced away from the image carrier to prevent the toner scattering.

However, since the direction of the airflow passing through the gap between the guiding part and the sheet feeding part and the sheet conveying direction are intersected each other, the airflow may be affected on the conveying of the sheet from the sheet feeding part to the guiding part. Accordingly, fine control is required to form the airflow so as not to interfere with the conveying of the sheet. Further, while the sheet is conveyed from the sheet feeding part to the guiding part, the airflow cannot be formed between the sheet feeding part and the guiding part and thus it is impossible to control the air generated when the leading end of the sheet hits the image carrier or the airflow generated when the rear end of the sheet is spaced away from the sheet feeding part. Therefore, degradation of image quality such as a lateral stripe generated due to these airflows cannot be restrained.

On the other hand, there is an image forming apparatus in which a sealing member abutting against the surface of the image carrier is provided between the guiding part and the development unit, preventing corona ions generated from a corona charging type transferring device from entering into a space on the side of the development unit.

The sealing member separates a space on the side of development unit from a space on the side of the transferring device so that the entering of airflow into the space on the side of the development unit is prevented as well. However, since the sealing member is provided between the space on the side of the development unit and the space on the side of the transferring device and abuts against the surface of the image carrier on which a toner image is formed, in order to distort the toner image, there is a need to cause the sealing member to be thin-filmed on the order of 50 microns in thickness. In a case where such a thin film is employed, although it is possible to prevent the entering of corona ions, it is impossible to surely prevent the entering of the airflow generated due to behavior of the sheet. If the thickness of the thin film is increased in order to reliably prevent the entering of the airflow, the sealing member may distort the toner image on the image carrier, causing degradation of image quality.

### SUMMARY

In accordance with an embodiment of the present disclosure, an image forming apparatus includes a development unit, a transferring device, a guiding part, a discharge flow path ad an airflow control mechanism. The development unit is configured to form a developing nip with an image carrier and develop an electrostatic latent image formed on the image carrier into a toner image at the developing nip. The transferring device is configured to transfer the toner image to a sheet fed from a sheet feeding part. The guiding part has an upper guiding plate disposed on a side of the development unit and a lower guiding plate disposed on a side of the transferring device. The upper guiding plate and the lower guiding plate form a sheet conveying path extending from the sheet feeding part to the transferring device between the development unit and the transferring device by. The discharge flow path is formed between the development unit and the guiding part and communicates with a sheet feeding part-side space where the sheet conveying path faces the sheet feeding part and an image carrier-side space where the sheet conveying path faces the image carrier. The airflow control mechanism is configured to guide airflow generated in the sheet feeding part-side space when a rear end of the sheet is separated from the sheet feeding part in a direction spaced away from the developing nip.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a schematic view showing an outline of a printer according to an embodiment of the present disclosure.

FIG. 2 is a front view showing an outline of an image forming unit according to the printer according to the embodiment of the present disclosure.

FIG. 3 is a front view showing a structure of an airflow control mechanism according to a first embodiment in the printer according to the embodiment of the present disclosure.

FIG. 4A is a view showing an upper guiding plate according to Example 1 seen from a right side, in the airflow control mechanism according to the first embodiment of the present disclosure.

FIG. 4B is a perspective view showing a guiding part of the upper guiding plate according to Example 1, in the airflow control mechanism according to the first embodiment of the present disclosure.

FIG. 5 is a front view showing an airflow controlling action exerted by the upper guiding plate according to Example 1, in the airflow control mechanism according to the first embodiment of the present disclosure.

FIG. 6 is a front view illustrating an upper guiding plate according to Example 2, in the airflow control mechanism according to the first embodiment of the present invention.

FIG. 7 is a view showing the upper guiding plate according to Example 2 seen from a right side, in the airflow control mechanism according to the first embodiment of the present invention.

FIG. 8 is a front view showing an upper guiding plate according to Example 3, in the airflow control mechanism according to the first embodiment of the present invention.

FIG. 9 is a view showing the upper guiding plate according to Example 3, in the airflow control mechanism according to the first embodiment of the present invention.

FIG. 10 is a front view showing a structure of an airflow control mechanism according to a second embodiment in a printer according to an embodiment of the present invention.

FIG. 11A is a front view showing an operation of an opening/closing member according to Example 1 when a leading end of a sheet reaches a photosensitive drum, in the airflow control mechanism according to the second embodiment of the present invention.

FIG. 11B is a front view showing an operation of the opening/closing member according to Example 1 when a rear end of the sheet is spaced away from a resist rollers pair, in the airflow control mechanism according to the second embodiment of the present invention.

FIG. 12A is a front view showing an operation of an opening/closing member according to Example 2 when a leading end of a sheet reaches a photosensitive drum, in the airflow control mechanism according to the second embodiment of the present invention.

FIG. 12B is a front view showing an operation of the opening/closing member according to Example 2 when a rear end of the sheet is spaced away from a resist rollers pair, in the airflow control mechanism according to the second embodiment of the present invention.

FIG. 13A is a front view showing an air flow generated when a rear end of a sheet is spaced away from an outlet of a resist rollers pair in a conventional printer.

FIG. 13B is a plan view showing a sheet with degraded image quality generated by air flow generated when a rear end of the sheet is spaced away from the outlet of the resist rollers pair in a conventional printer.

FIG. 14 is a front view showing a wind shielding member provided between a guiding part and the resist rollers pair in a conventional printer.

FIG. 15A is a front view showing air flow generated when a leading end of a sheet comes into contact with a photosensitive drum in a case where a wind shielding member is provided between the guiding part and a development unit in a conventional printer.

FIG. 15B is a plan view showing a sheet with degraded image quality generated by air flow generated when a leading end of the sheet comes into contact with the photosensitive drum in a conventional printer.

### DETAILED DESCRIPTION

In the following, with reference the drawings, an image forming apparatus according to an embodiment of the present disclosure will be described.

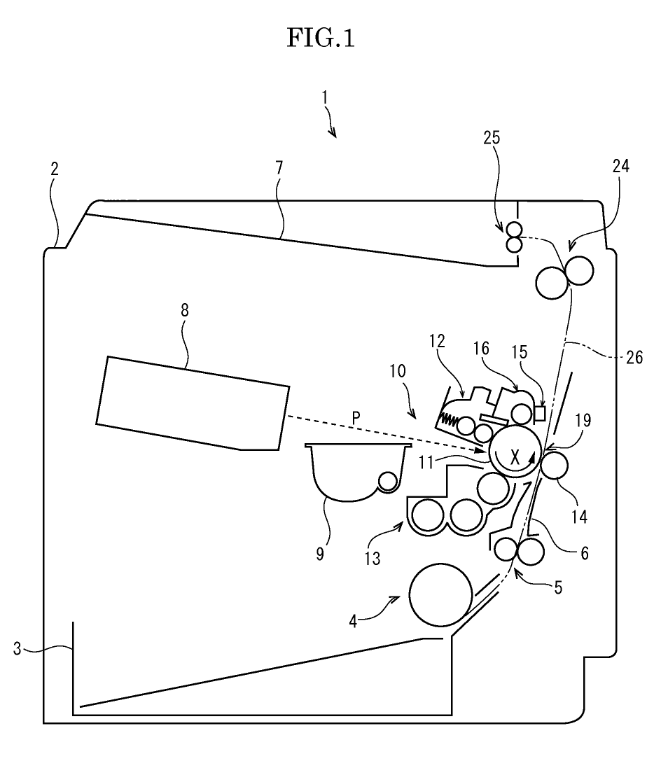

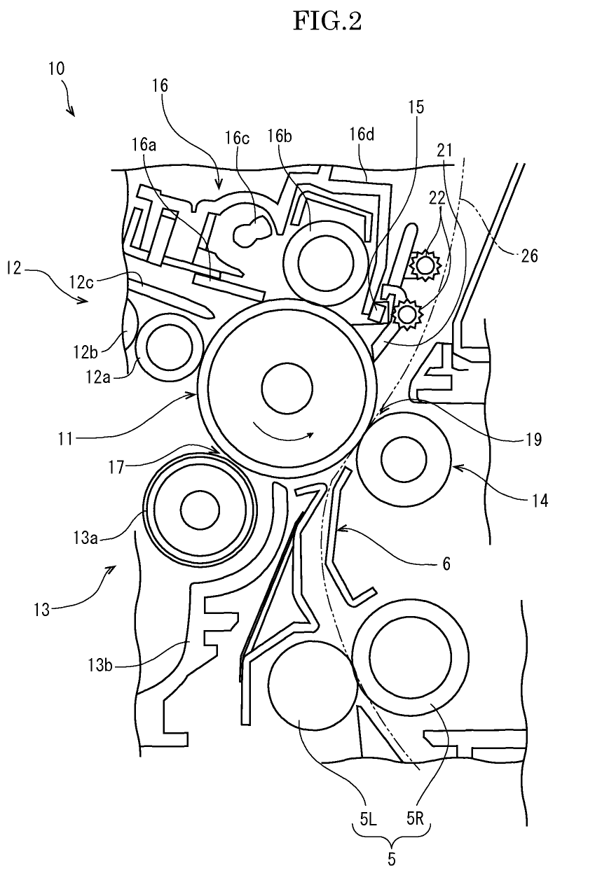

With reference to FIGS. 1 and 2, a main structure of a printer (image forming apparatus) according to one embodiment of the present disclosure will be described. FIG. 1 is a schematic diagram showing an internal structure of the printer and FIG. 2 is a view showing a structure of an image forming part. In the following description, a near side on a paper plane indicates a front side of the printer 1 and left and right directions are based on a direction viewed from the front side of the printer 1.

The printer 1 includes a box-formed printer main body 2. In a lower part of the printer main body 2, a sheet feeder 4 configured to feed a recording sheet from a sheet storing cartridge 4 storing the sheet (not shown) is provided. On upper right side of the sheet feeder 4, a resist rollers pair 5 (sheet feeding part) having a pair of left and right rollers 5L, 5R is provided. Above the resist rollers pair 5, a guiding part 6 is provided. On an upper face of the printer main body 2, an ejected sheet tray 7 is formed. Inside of the printer main body 2, an exposure device 8 composed of a laser scanning unit (LSU) and a toner container 9 storing a toner are provided in the left space and the center space, respectively. On a right side of the toner container 9, an image forming part 10 is provided.

Referring to FIG. 2, the image forming part 10 will be described. In the image forming part 10, a photosensitive drum 11 as an image carrier is rotatably provided. Around the photosensitive drum 11, a charger 12, a development unit 13, a transfer roller 14 (transferring device), a static eliminator 15 and a cleaning device 16 are arranged along a rotating direction (refer to an arrow X in FIG. 1) of the photosensitive drum 11.

The charger 12 includes a charging roller 12a configured to come in contact with the photosensitive drum 11 to charge the photosensitive drum 11 and a cleaning roller 12b configured to clean the charging roller 12a. The charging roller 12a and the cleaning roller 12b are supported by a supporting member 12c.

The development unit 13 of a jumping development type includes a development roller 13a configured to supply the toner to the photosensitive drum 11, a magnetic roller and an agitating roller (both are not shown). By applying voltage with the same polarity as the charge polarity of the toner on the development roller 13a, the toner flies toward a surface of the photosensitive drum 11. The development roller 13a, the magnetic roller and the agitating roller are housed in a supporting member 13b. The supporting member 13b has an opening facing the photosensitive drum 11. Between the development roller 13a and the photosensitive drum 11 through the opening, a development nip 17 is formed.

The transferring roller 14 forms a transferring nip 19 with the photosensitive drum 11. To the transferring roller 14, a predetermined transferring bias voltage is applied.

The cleaning device 16 includes a cleaning blade 16a configured to come in contact with the surface of the photosensitive drum 11, a cleaning roller 16b configured to supply the toner to the surface of the photosensitive drum 11 and a toner recovery spiral 16c configured to recover the toner scraped from the cleaning roller 16b. The cleaning blade 16a, the cleaning roller 16b and the recovery spiral 16c are housed in a supporting member 16d. In a side face of the supporting member 16d on a side of the transferring nip 19, the static eliminator 15, a separating craw 21 and a conveying assistant member 22 are provided.

Referring to FIG. 1 again, above the image forming part 10, a fixing device 24 is provided. On upper left side of the fixing device 24, a sheet ejecting unit 25 facing the sheet ejected tray 7 is provided.

Inside the printer main body 2, a sheet conveying path 26 extending from the sheet feeder 4 to the sheet ejecting unit 25 through the resist rollers pair 5, the guiding part 6, the transferring nip 19 and the fixing device 24 is provided.

Next, an operation of forming an image by the printer 1 having such a configuration will be described. When the power is supplied to the printer 1, image forming operation is carried out as follows.

First, the surface of the photosensitive drum 11 is electric-charged by the charger 12. Then, exposure corresponding to the image data on the photosensitive drum 11 is carried out by a laser light (refer to two-dashed line P in FIG. 1) from the exposure device 8, thereby forming an electrostatic latent image on the surface of the photosensitive drum 11. Subsequently, the electrostatic latent image is developed by the development unit 13 into a toner image.

On the other hand, the sheet fed from the sheet feeding cartridge 3 by the sheet feeder 4 is guided by the guiding part 6 and conveyed to the transferring nip 19 with synchronizing with the above-mentioned image forming operation. At the transferring nip 19, by applying the predetermined electrostatic transferring bias to the transferring roller 14, the toner image on the photosensitive drum 11 is transferred to the sheet. The sheet with the transferred toner image is conveyed on a downstream side along the sheet conveying path 26 to go forward to the fixing device 24, and then, the toner image is fixed on the sheet in the fixing device 24. The sheet with the fixed toner image is ejected from the sheet ejecting unit 25 to the ejected sheet tray 7. The toner remained on the photosensitive drum 11 is collected by the cleaning device 16.

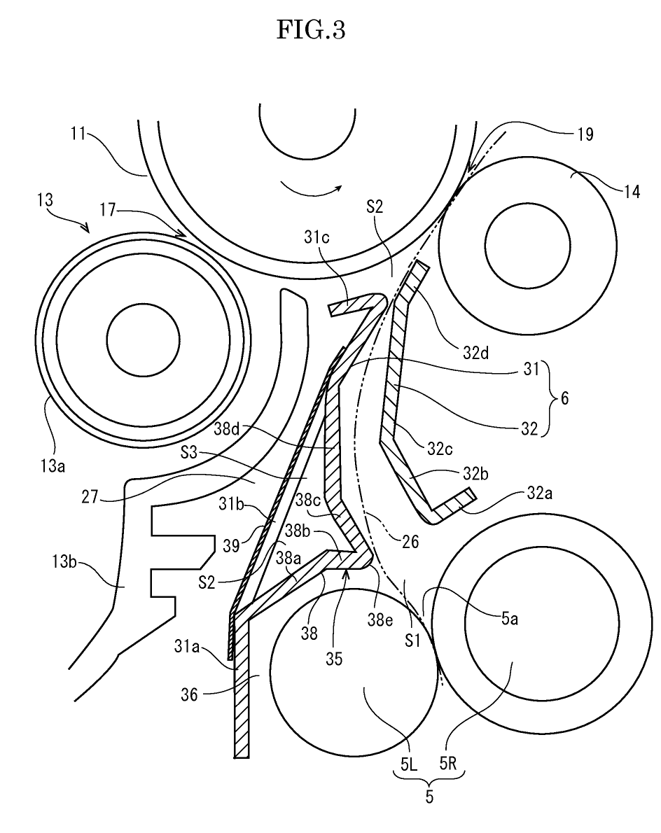

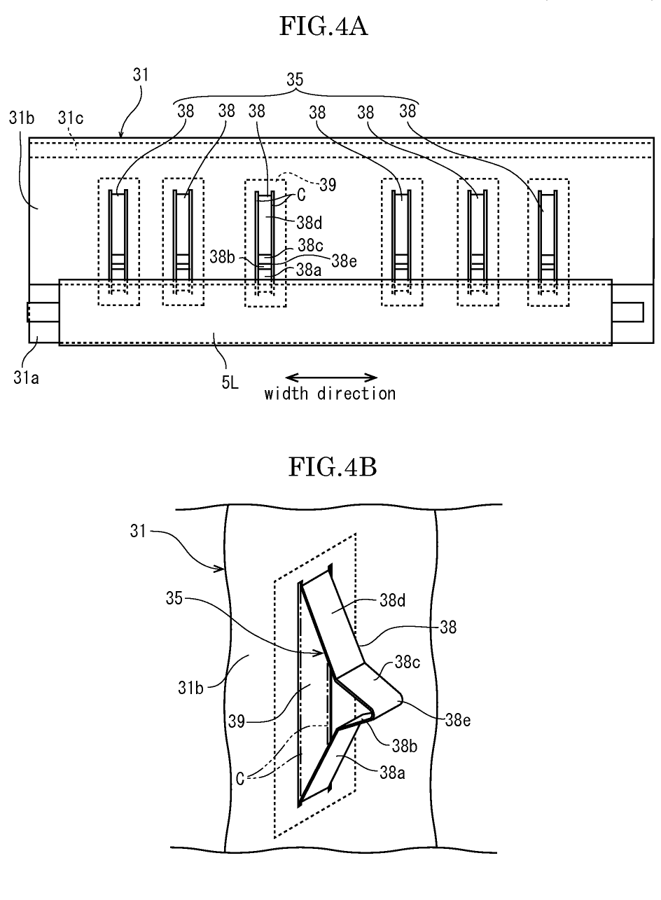

Next, with reference to FIGS. 3 to 4B, a guiding part 6 including an airflow control mechanism, according to a first embodiment, will be described. FIG. 3 is a front view showing the guiding part, FIG. 4A is a view showing an upper guiding plate seen from a right side, and FIG. 4B is a perspective view showing a bent plate provided at the upper guiding plate.

As shown in FIG. 3, the guiding part 6 has an upper guiding plate 31 and a lower guiding plate 32. The upper guiding plate 31 and the lower guiding plate 32 are arranged on a side of the development unit 13 and on a side of the transferring nip 19 across an outlet 5a of a resist rollers pair 5, respectively. The guiding part 6 forms the sheet conveying path 26 and a discharge flow path 27, between the development unit 13 and the transferring nip 19. The sheet conveying path 26 extends vertically from the outlet 5a of the resist rollers pair 5 to the transferring nip 19 along the surface of the photosensitive drum 11. The discharge flow path 27 is formed between the guiding part 6 and the development unit 13 so as to communicate a sheet feeding part-side space S1 where the sheet conveying path 26 faces the outlet 5a of the resist rollers pair 5 and a photosensitive drum-side space S2 (image carrier-side space) where the sheet conveying path 26 faces the surface of the photosensitive drum 11.

The upper guiding plate 31 has a resist roller opposing portion 31a (extended portion) on a left side of the left resist roller 5L, an inclined portion 31b extending in an obliquely upper right direction from an upper end of the resist roller opposing portion 31a toward the surface of the photosensitive drum 11, and a photosensitive drum opposing portion 31c bent at an acute angle from an upper end of the inclined portion 31b toward the development unit 13 and opposing the surface of the photosensitive drum 11.

The resist roller opposing portion 31a is formed so as to extend in a direction spaced away from the transferring roller 14 through a space between the left resist roller 5L and the development unit 13. With this structure, between the resist roller opposing portion 31a and the left resist roller 5L, an airflow control path 36 (airflow control mechanism) communicating with the sheet feeding part-side space S1 and extending in a direction spaced away from the photosensitive drum-side space S2 is formed. A lower opening of the airflow control path 36 opens downward and communicates with the discharge flow path 27.

The upper guiding plate 31 has an inside guiding part 35 protruding toward the sheet conveying path 26. The inside guiding part 35 according to Example 1 will be described. The inside guiding part 35, as shown in FIG. 4A, is composed of six bent plates 38 (protruding portion), and each of the bent plates 38 is formed so as to protrude rightward from a right side face of the inclined portion 31b of the upper guiding plate 31 (face on the side of the sheet conveying path 26) and extend along the conveying direction. The respective bent plates 38 are disposed in parallel to each other by three on both sides of a center in a sheet width direction orthogonal to the conveying direction. The pair of bent plates 38 located on the innermost side are disposed at intervals which are smaller than a width of a postcard. As an example, the innermost pair of bent plates 38 are disposed such that the both outer side edges are located inward by 5 mm more than the both side edges of the postcard. A middle pair of bent plates 38 located outward from the innermost pair of bent plates 38 and an outermost pair of bent plates 38 located on the outermost side are disposed at intervals which are smaller than a standard width of a sheet to be fed (for example, a short-edge length and a long-edge length of A4 size sheet).

The bent plate 38, as shown in FIG. 4B, is formed by bending a plate-shaped piece of a predetermined width into substantially a triangular side shape along five horizontal lines. Such a bent plate 38, as shown in FIG. 4A, can be formed, for example, by forming the upper guiding plate 31 of a plate metal material, forming a pair of parallel vertical slits C, cutting and raising an elongated rectangular portion between the slits C, and bending the cut and raised portion into the substantially triangular side shape along the five horizontal lines by partial throttle processing.

By forming the bent plate 38 in the above-mentioned way, a punched hole is formed between the slits C in the upper guiding plate 31. Each punched hole is closed by a sealing member 39 from an outside of the upper guiding plate 31 (face on the side of the discharge flow path 27). As a material for the sealing member 39, for example, polyester or PET (Polyethylene terephthalate) can be used.

Each bent plate 38, as shown in FIG. 3, has an inclined portion 38a opposing to an upper right face of the left resist roller 5L and extending in an oblique upper right direction, a horizontal portion 38b opposing to an upper face of the left resist roller 5L and extending substantially horizontally, an inclined portion 38c curving from the horizontal portion 38b at an acute angle and extending in an oblique upper left direction and a vertical portion 38d extending upward substantially vertically from an upper end of the inclined portion 38c. A corner 38e between the horizontal portion 38b and the inclined portion 38c protrudes up to the closest position to the outlet 5a of the resist rollers pair 5 and is provided to be slightly more leftward than the outlet 5a so as not to interfere with the leading end of the sheet P that is ejected from the outlet 5a.

A space S3 between the adjacent bent plates 38 and the right side face of the upper guiding plate 31 communicates with the airflow control path 36.

The lower guiding plate 32 has a resist roller opposing portion 32a opposing an upper face of the right resist roller 5R via a gap, a lower guiding portion 32b extending to an oblique upper left direction from an left end of the resist roller opposing portion 32a, an upper guiding portion 32c extending upward substantially vertically from an upper end of the lower guiding portion 32b and a photosensitive drum opposing portion 32d extending from an upper end of the upper guiding portion 32c so as to oppose to the photosensitive drum 11 via a gap.

By the inside guiding part 35 of the upper guiding plate 31 and the lower guiding plate 32, the sheet conveying path 26 is formed so as to be narrow from the resist rollers pair 5 toward the photosensitive drum 11 and curve in a slightly upper rightward direction. In this sheet conveying path 26, the sheet P comes into contact with the photosensitive drum along a substantially tangential direction of the photosensitive drum 11 on a downstream side from the transferring nip 19 in the rotational direction of the photosensitive drum 11 and then is conveyed to the transferring nip 19.

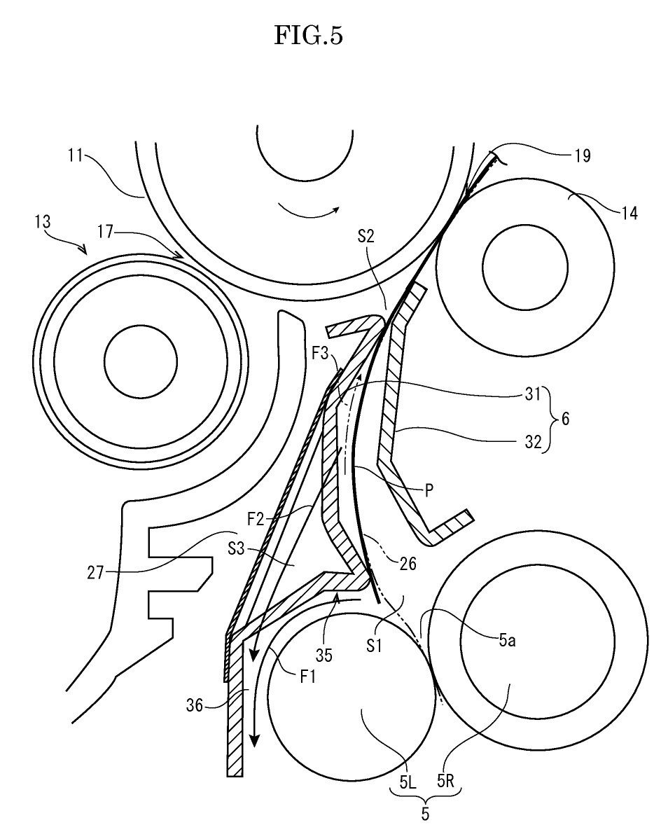

With reference to FIG. 5, an operation in which the sheet P is conveyed to the transferring nip 19 in the printer 1 having the above configuration will be described. FIG. 5 shows a state in which the rear end of the sheet is spaced away from the outlet of the resist rollers pair.

In a state in which no image forming operation is carried out, the toner or the like scattering around the photosensitive drum 11 is removed from the photosensitive drum 11 through the discharge flow path 27. When the image forming operation is started, the sheet is fed out from the sheet feeding cassette 3 by the sheet feeder 4. Then, after detecting a position of the leading end of the sheet P by a sensor (not shown) at the pair of resist rollers 5, the detected position of the leading end of the sheet P and the position of the toner image formed on the surface of the photosensitive drum 11 are synchronized with each other and then the sheet is ejected from the outlet 5a of the resist rollers pair 5.

The sheet P ejected from the outlet 5a of the resist rollers pair 5 enters the guiding part 6 and then is conveyed along the sheet conveying path 26. At this juncture, a left side face of the sheet P is guided along a right face of each bent plate 38, in the inside guiding part 35 of the upper guiding plate 31. When the sheet P is further conveyed and separated from the outlet 5a of the resist rollers pair 5, an airflow F1 directing leftward is generated in the sheet feeding part-side space S1. As shown in FIG. 5, this airflow F1 flows into the airflow control path 36 and then is released from the lower opening of the airflow control path 36. Also, during conveying of the sheet P, air between the left side face of the sheet P and the right end face of each bent plate 38 or the right side face of the upper guiding plate 31 is compressed to generate an airflow F2 directing leftward in the space S3 between the adjacent bent plates 38 and the upper guide plate 31. This airflow F2 flows from the space S3 into the airflow control path 36 and then is released from the lower opening of the airflow control path 36.

As has been described above, in the printer 1 according to the embodiment, the airflow F1 generated when the rear end of the sheet P is separated from the outlet 5a of the resist rollers pair 5 flows downward (in the direction spaced away from the developing nip 17) along the airflow control path 36 and then is released. Although the released airflow flows into the discharge flow path 27 as well, since the lower opening of the airflow control path 36 is spaced away from the developing nip 17, no airflow passing though the discharge flow path 27 toward the developing nip 17 is generated. Therefore, the behavior of the sheet P when separated from the resist rollers pair 5 does not affect the toner image forming operation in the developing nip 17 and thus degradation of image quality such as generation of lateral stripe can be prevented.

By providing the inside guiding part 35 on the upper guiding plate 31, the rear end of the sheet P separated from the outlet 5a of the resist rollers pair 5 hits the corner 38e of each bent plate 38 at a close position to the outlet 5a. Accordingly, an impact applied on the sheet P when separated from the outlet 5a can be buffered.

Incidentally, in a case where the entire of the upper guiding plate 31 is formed to be bent like the bent plate 38 (the shape indicated by hatching of FIG. 5), the following problem occurs. That is, after the sheet P has entered the guiding part 6, the left side face of the sheet P comes into contact with a portion protruding rightward from the upper guiding part 31 (a portion corresponding to the corner 38e of the bent plate 38) and then the sheet is conveyed upward. At this juncture, in an upper space from the protruding portion of the upper guiding plate 31, there is a possibility that air in a space between the upper guiding plate 31 and the sheet P is compressed to generate an airflow (indicated by F3 in FIG. 5) directing upward (the direction toward the photosensitive drum 11). If such airflow directs from the guiding part 6 to the photosensitive drum 11, the toner image formed on the photosensitive drum 11 may be affected.

Furthermore, in the present embodiment, since a width of each bent plates 38 along which the left side face of the sheet P is to be guided is narrower than a width of the sheet P, compression of the air between the sheet P and the bent plates 38 hardly occurs. And further, since the space S3 between the adjacent bent plates 38 and the upper guiding plate 31 communicates with the airflow control path 36, the airflow F2 directing leftward, that is generated between the sheet P and the upper guiding plate 31, can be directed toward the airflow control path 36 through the space S3 and then to be released.

Furthermore, since the bent plates 38 are disposed at intervals which are smaller than a standard width of the sheet to be fed, the sheet P having the standard width will be hardly sandwiched between the bent plates 38.

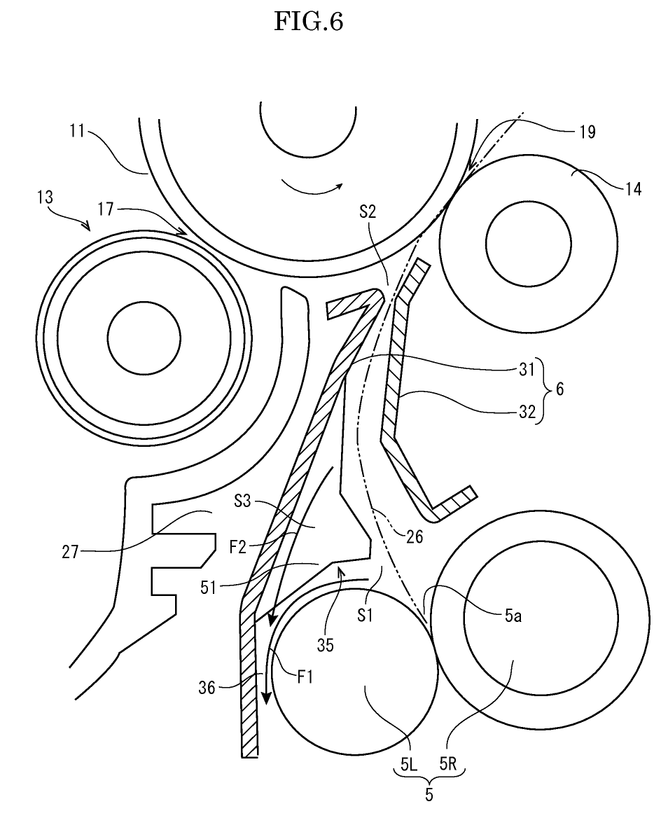

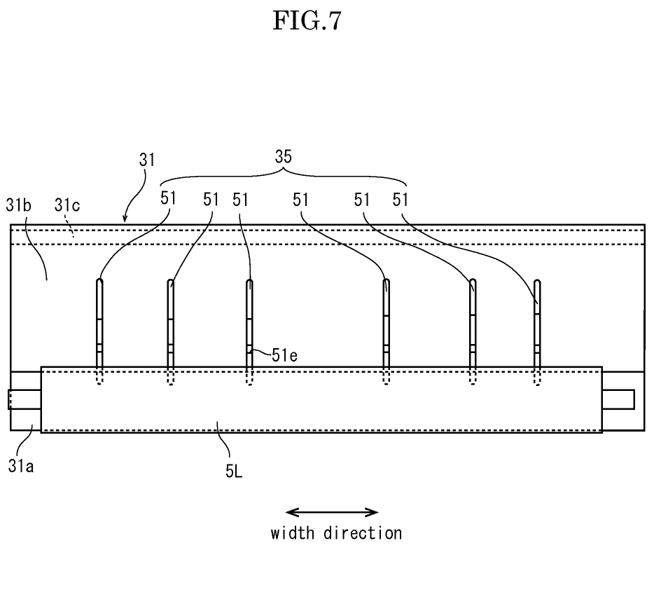

Next, with reference to FIGS. 6 to 7, an inside guiding part 35 according to Example 2 will be described. FIG. 6 is a front view showing the guiding part, and FIG. 7 is a view showing an upper guiding plate seen from a right side.

The inside guiding part 35, as shown in FIG. 7, is composed of six plate-shaped ribs 51, and each of the ribs 51 is formed so as to protrude rightward from the right side face of the inclined portion 31b of the upper guiding plate 31 (face on the sheet conveying path side) and extend along the conveying direction. The ribs 51 have a front shape similar to the front shape of the bent plate 38 of the inside guiding part 35 according to Example 1, and as with the bent plate 38, are disposed in parallel to each other by three on both sides of the center in the sheet width direction orthogonal to the sheet conveying direction. Such ribs 51 can be provided integrally with the right side face of the upper guiding plate 31 made of a resin.

In the inside guiding part 35 of Example 2 as well, the sheet P ejected from the outlet 5a of the resist rollers pair 5 is guided along the right end face of each rib 51 of the upper guiding plate 31. The airflow F1 generated when the sheet P is separated from the outlet 5a of the resist rollers pair 5 flows into the airflow control path 36 and then is released from the lower opening of the airflow control path 36. Also, during conveying of the sheet P, the airflow F2 directing leftward generated in the space P3 between the adjacent ribs 51 and the upper guiding plate 31 by compressing the air between the left side face of the sheet P and the right side face of the upper guiding plate 31 flows from the space S3 into the airflow control path 36 and then is released from the lower opening of the airflow control path 36. In this embodiment, since the shape of the rib 51 is plate-shaped and the flow of air in the width direction is not generated in the space between the adjacent ribs 51, the airflow F2 can be surely directed toward the airflow control path 36.

In a case where the inside guiding part 35 is composed of the plurality of bent plates 38 or ribs 51 as mentioned above, since the respective bent plates 38 and ribs 51 can be formed for a comparatively long distance along the sheet conveying path 26, the sheet P can be stably conveyed along the conveying direction.

Incidentally, the number of bent plates 38 or ribs 51 is not limited to six. In addition, the upper guiding plate 31 and the inside guiding part 35 may be integrally formed or may be separately formed. Furthermore, a material for the upper guiding plate 1 is not limited to a metal plate material or a resin material.

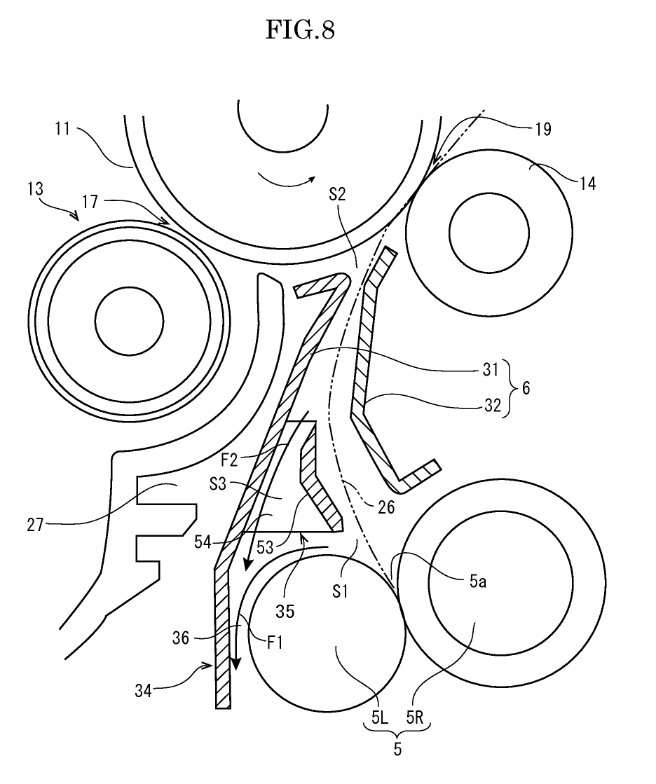

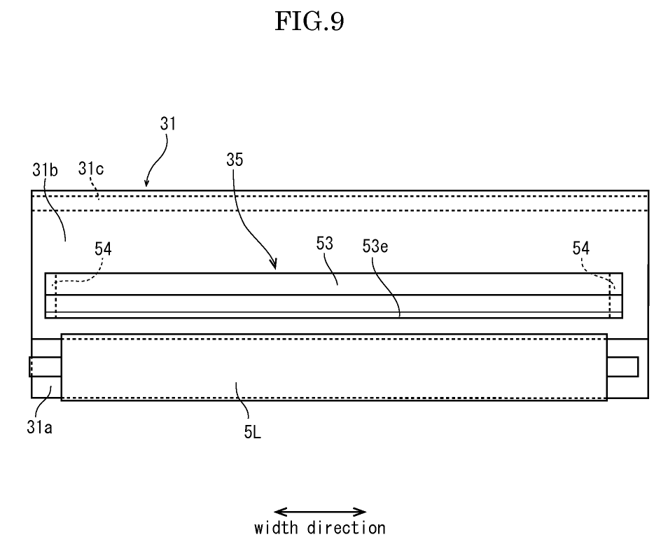

With reference to FIGS. 8 to 9, an inside guiding part 35 according to Example 3 will be described. FIG. 8 is a front view showing the guiding part, and FIG. 9 is a view showing an upper guiding plate seen from a right side.

The inside guiding part 35 is composed of a plate-shaped member 53 extending in the sheet width direction. At a substantial center in the vertical direction on the right face of the inclined portion 31b of the upper guiding plate 31, leg parts 54 are respectively formed at both ends in the sheet width direction, and the plate-shaped member 53 is bridged between the leg parts 54. A space S3 is formed between the plate-shaped member 53 and the upper guiding plate 31, and an upper opening of the space S3 communicates with the sheet conveying path 26, and a lower opening thereof communicates with the airflow control path 36.

The sheet P ejected from the outlet 5a of the resist rollers pair 5 is guided along a right face of the plate-shaped member 53 and then along the right side face of the upper guiding plate 31 after passing through the plate-shaped member 53. The airflow F1 generated when the sheet P is separated from the outlet 5a of the resist rollers pair 5 flows into the airflow control path 36 and then is released from the lower opening of the airflow control path 36. Also, the airflow F2 generated by compressing the air between the sheet P and the plate-shaped member 53 or the upper guiding plate 31 enters the airflow control path 36 from the space S3 and then is released from the lower opening of the airflow control path 36.

In Example 3, since the plate-shaped member 53 is bridged all over the sheet width direction, a sheet P of a variety of widths can be conveyed smoothly. For example, in the case of the bent plates 38 or the ribs 51 shown in FIG. 3, FIG. 6 or the like, if a sheet P has a nonstandard width, the sheet P may be sandwiched between the bent plates 38 or the ribs 51. On the contrary, since the plate-shaped member 53 is provided so as to extend in the sheet width direction, the sheet P having a nonstandard width can be reliably conveyed as well.

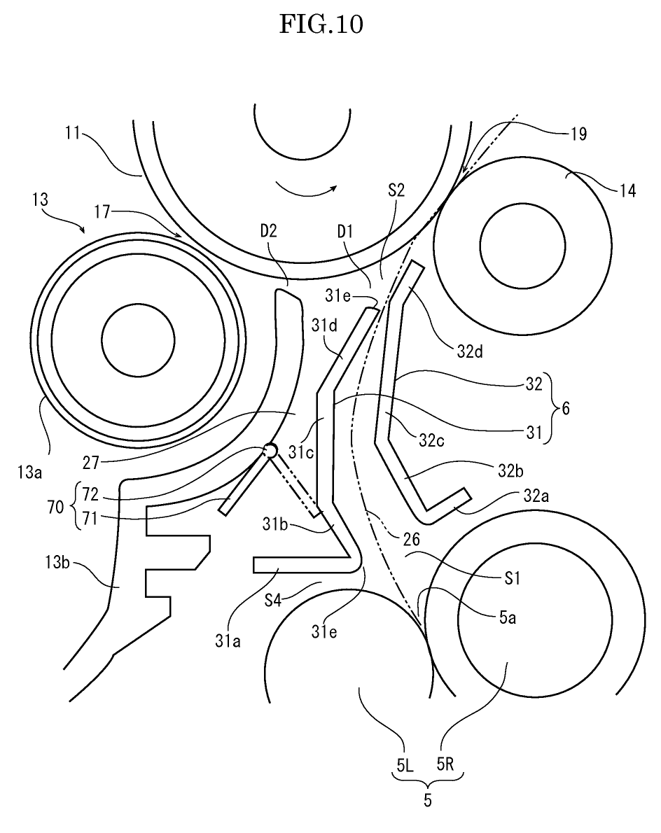

Next, with reference to FIG. 10, a guiding part 6 including an airflow control mechanism according to the second embodiment, will be described.

The guiding part 6 has an upper guiding plate 31 and a lower guiding plate 32. The upper guiding plate 31 and the lower guiding plate 32 are arranged on a side of the development unit 13 and on a side of the transferring nip 19 across an outlet 5a of a resist rollers pair 5, respectively. The guiding part 6 forms the sheet conveying path 26 and a discharge flow path 27, between the development unit 13 and the transferring nip 19. The sheet conveying path 26 extends vertically from the outlet 5a of the resist rollers pair 5 to the transferring nip 19 along the surface of the photosensitive drum 11. The discharge flow path 27 is formed between the guiding part 6 and the development unit 13 so as to communicate a sheet feeding part-side space S1 where the sheet conveying path 26 faces the outlet 5a of the resist rollers pair 5 and a photosensitive drum-side space S2 where the sheet conveying path 26 faces the surface of the photosensitive drum 11.

The upper guiding plate 31 has a resist roller opposing portion 31a on the left side of the left resist roller 5L via a gap, a lower guiding portion 31b extending in an oblique upper left direction from a right end of the resist roller opposing portion 31a, a middle guiding portion 31c extending substantially vertically from an upper end of the lower guiding portion 31b and an upper guiding portion 31d extending in an oblique upper right direction from an upper end of the middle guiding portion 31c toward the surface of the photosensitive drum 11.

A corner 31e between the resist roller opposing portion 31a and the lower guiding portion 31b is formed at an acute angle and so as to be closest to the outlet 5a of the resist rollers pair 5. However, the corner 31e is provided to be slightly more leftward than the outlet 5a so as not to interfere with the leading end of the sheet P passing through the outlet 5a of the resist rollers pair 5.

In addition, the upper guiding plate 31 is provided so that a total area in an opening D1 between a photosensitive drum side end 31e of the upper guiding part 31d and the surface of the photosensitive drum 11 is larger than a total area of an opening D2 between the supporting member 13b of the development unit 13 and the surface of the photosensitive drum 11. Further, the discharge flow path 27 is formed so that a total area thereof is larger than the total area in the opening D2 between the supporting member 13b of the development unit 13 and the surface of the photosensitive drum 11.

The lower guiding plate 32 has a resist roller opposing portion 32a opposing the upper face the right resist roller 5R via a gap, a lower guiding portion 32b extending in an oblique upper left direction from a left end of the resist roller opposing portion 32a, an upper guiding part 32 extending substantially vertically from an upper end of the lower guiding portion 32b and a photosensitive drum opposing portion 32d extending from an upper end of the upper guiding portion 32c so as to oppose to the photosensitive drum 11 via a gap.

By the upper guiding plate 31 and the lower guiding plate 32, the sheet conveying path 26 is formed so as to be narrow from the resist rollers pair 5 toward the photosensitive drum 11 and curve in a slightly upper rightward direction. In this sheet conveying path 26, the sheet P comes into contact with the photosensitive drum 11 along a substantially tangential direction of the photosensitive drum 11 on a downstream side from the transferring nip 19 in the rotational direction of the photosensitive drum 11 and then is conveyed to the transferring nip 19.

In the middle of the discharge flow path 27, an opening/closing member 70 (airflow control mechanism) to open/close the discharge flow path 27 is provided. With reference to FIG. 10, the opening/closing member 70 according to Example 1 will be described. The opening/closing member 70 has a shutter plate 71 (shutter member) and a rotating shaft 72. The rotating shaft 72 is turnably supported on an outer face of the supporting member 13b of the development unit 13, and the shutter plate 71 turns between a closed position (indicated by the double-dotted chain line of FIG. 10) at which the discharge flow path 27 is closed and an open position at which the discharge flow path 27 is opened. At the closed position, the shutter plate 71 turns until the tip end abuts against the outer face of the middle guiding portion 31c of the upper guiding plate 31 to close the discharge flow path 27, and at the open position, the shutter plate 71 turns to abut against the outer face of the supporting member 13b to open the discharge flow path 27.

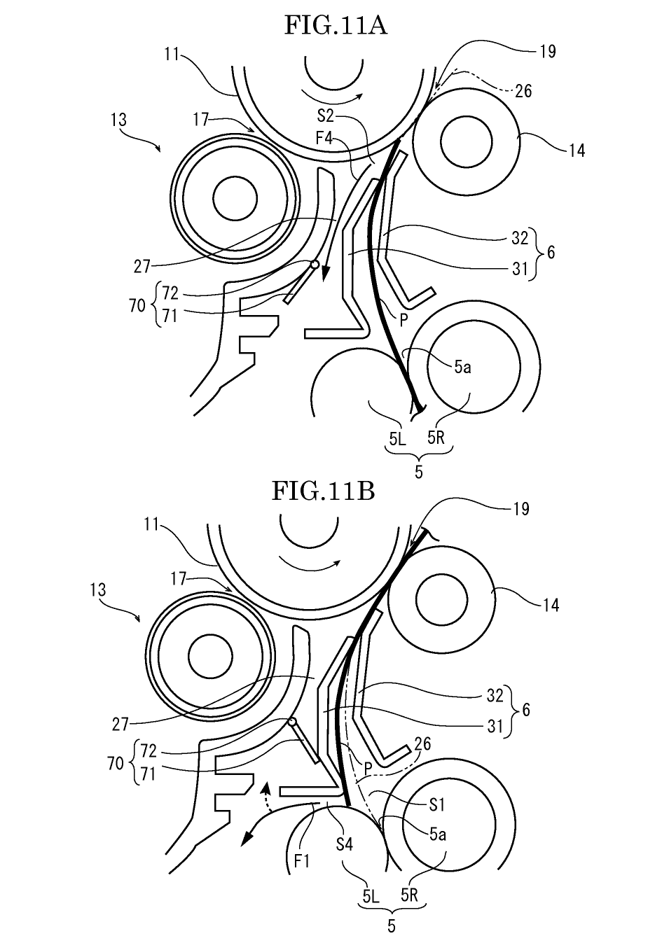

With reference to FIGS. 11A to 11B, a behavior of the opening/closing member 70 when the sheet P is conveyed to the transferring nip 19 in the printer 1 having the above configuration will be described. FIG. 11A shows a state in which the leading end of the sheet reaches the photosensitive drum and FIG. 11B shows a state in which the rear end of the sheet is separated from the outlet of the resist rollers pair.

In a state in which no image forming operation is carried out, as shown in FIG. 11A, in the opening/closing member 70, the shutter plate 71 turns to the open position, and a toner or the like scattering around the photosensitive drum 11 is removed from the photosensitive drum 11 through the discharge flow path 27. When the image forming operation is started, the sheet P is fed out from the sheet feeding cassette 3 by the sheet feeding device 4. Then, after detecting a position of the leading end of the sheet P by a sensor (not shown) at the pair of resist rollers 5, the detected position of the leading end of the sheet P and a position of the toner image formed on the surface of the photosensitive drum 11 are synchronized with each other and then the sheet is ejected from the outlet 5a of the resist rollers pair 5.

The sheet P ejected from the outlet 5a of the resist rollers pair 5 is conveyed along the sheet conveying path 26 of the guiding part 6, and comes into contact with the surface of the photosensitive drum 11. Owing to this contact, as shown in FIG. 11A, an airflow F4 is generated in the photosensitive drum-side space S2. Here, as mentioned above, the shutter plate 71 of the opening/closing member 70 turns to the open position to open the discharge flow path. And, a total area in the opening D1 between the photosensitive drum side end 31e of the upper guiding plate 31 and the surface of the photosensitive drum 11 is larger than a total area in the opening D2 between the supporting member 13b of the development unit 13 and the surface of the photosensitive drum 11, and a total area of the discharge flow path 27 is larger than the total area in the opening D2 between the supporting member 13b of the development unit 13 and the surface of the photosensitive drum 11. Accordingly, as indicated by the arrow of FIG. 11A, the airflow A4 flows toward the discharge flow path 27 not toward the developing nip 17. That is, the airflow F4 hardly affects the developing nip 17.

Immediately before the sheet P is further conveyed and the rear end thereof is separated from the outlet 5a of the resist rollers pair 5, the opening/closing member 70 is driven so that the shutter plate 71 turns to the closed position to close the discharge flow path 27. When the sheet P is separated from the resist rollers pair 5, the rear end of the sheet P hits the corner 31e of the upper guiding plate 31 in the sheet conveying path 26 of the guiding part 6. This generates the airflow F1 from the sheet feeding part-side space S1 toward a space S4 between the resist roller opposing portion 31a of the upper guiding plate 31 and the left resist roller 5L. As shown in FIG. 11B, although a part of this airflow F1 (refer to the dotted line of FIG. 11B) flows into the discharge flow path 27, since the discharge flow path 27 is closed, the airflow F1 never flows through the discharge flow path 27 upward and, therefore, does not reach the surface of the photosensitive drum 11 or the developing nip 17. That is, the airflow F4 hardly affects the toner image formed on the photosensitive drum 11. When the rear end of the sheet P advances into the guiding part 6, the opening/closing member 70 is driven so that the shutter plate 71 turns to the open position.

As described above, in the printer 1 according to the embodiment, since the discharge flow path 27 is opened/closed by the opening/closing member 70 in accordance with the conveying position of the sheet P, the airflow generated when the leading end of the sheet ejected from the resist rollers pair 5 hits the photosensitive drum 11 and the airflow generated when the rear end of the sheet P is separated from the outlet 5a of the resist rollers pair 5 can be flowed in the direction spaced away from the developing nip 17. Therefore, since an influence due to the behavior of the sheet P on the development operation in the developing nip 17 can be reduced, degradation in image quality such as generation of lateral stripe can be prevented.

Further, the total area in the opening D2 between the supporting member 13b of the development unit 13 and the surface of the photosensitive drum 11 is formed to be smaller than the total area in the opening D1 between the photosensitive drum side end 31e of the upper guiding plate 31 of the guiding part 6 and the surface of the photosensitive drum 11, and the total area of the discharge flow path 27 is formed to be larger than the total area in the opening D2 between the supporting member 13b of the development unit 13 and the surface of the photosensitive drum 11. With such a structure, the airflow generated in the photosensitive drum-side space S2 when the leading end of the sheet P hits the surface of the photosensitive drum 11 hardly enters the developing nip 17 and easily enters the discharge flow path 27. Therefore, the generated airflow can be smoothly introduced into the discharge flow path 27, and can be hardly affected by the developing nip 17.

Furthermore, turning of the shutter plate 71 of the opening/closing member 70 can be easily controlled on the basis of a size of the sheet P or a timing or the like of ejecting the sheet P from the resist rollers pair 5.

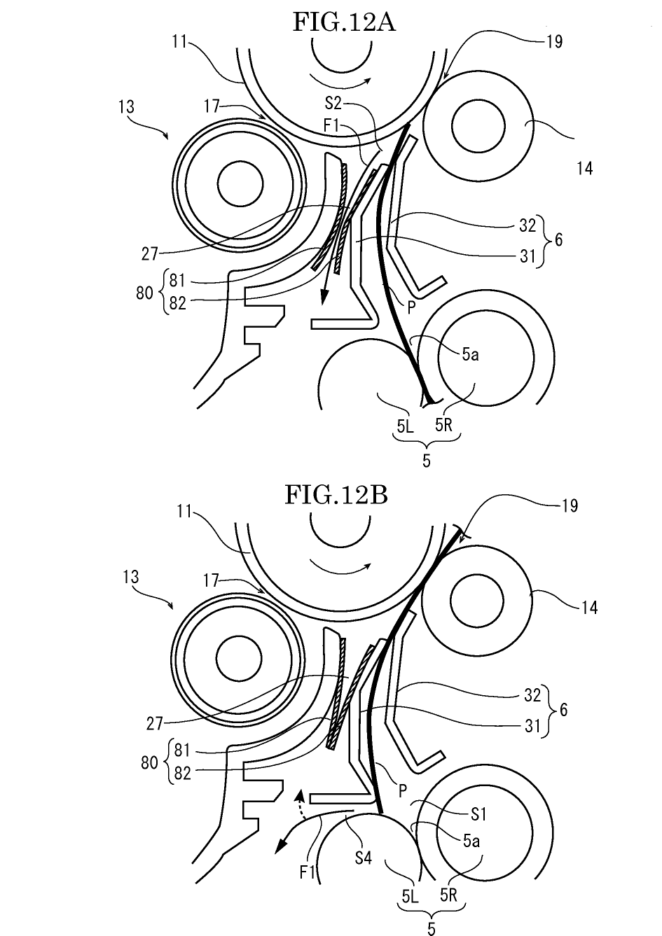

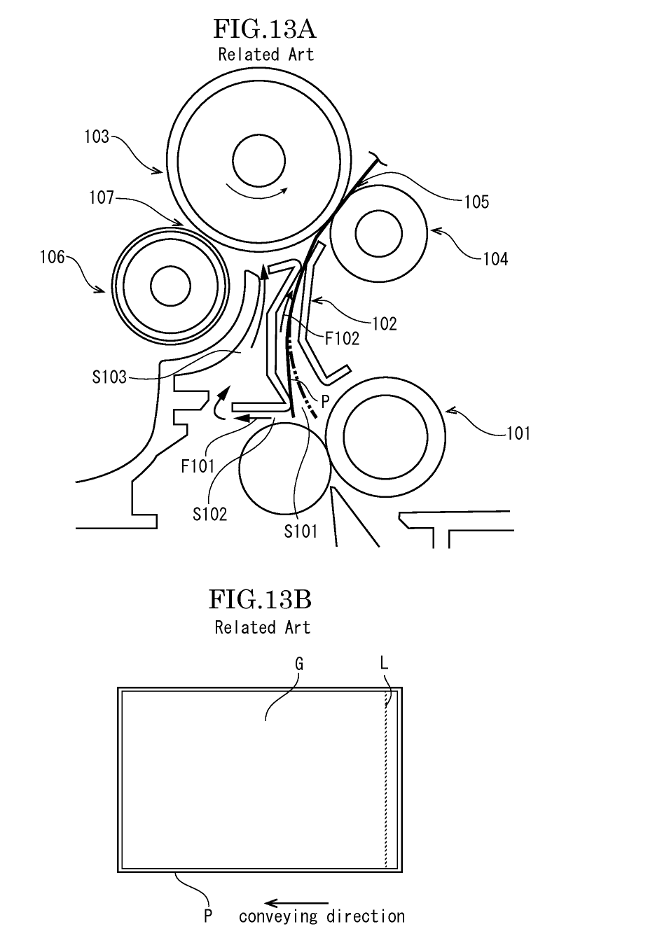

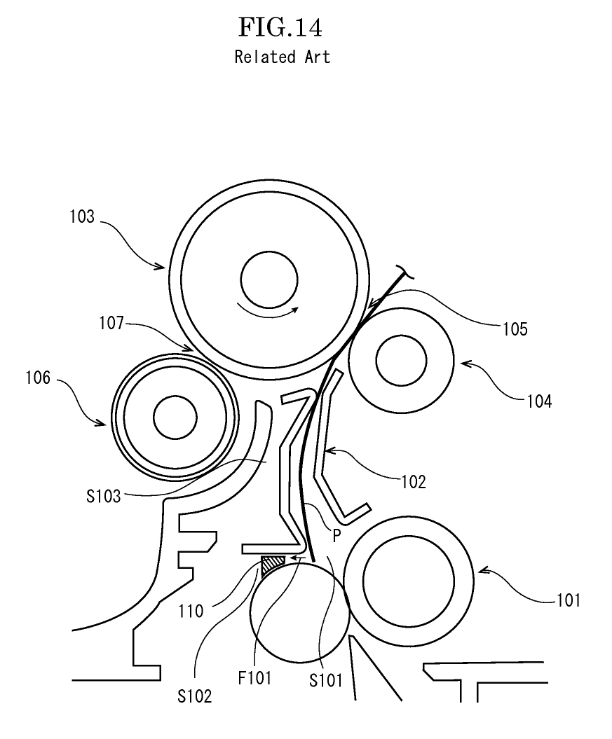

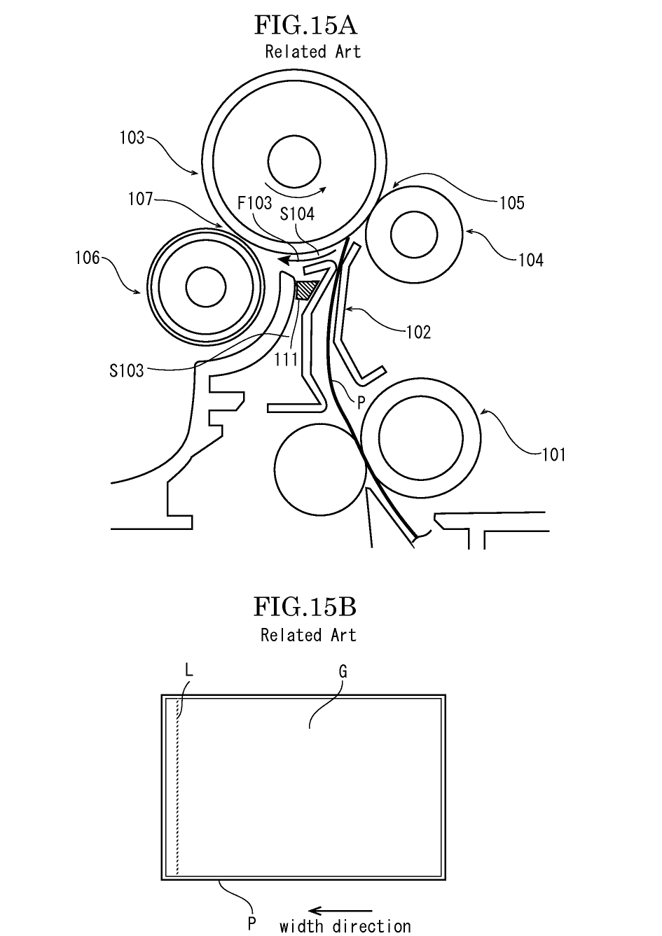

With respect to FIGS. 12A to 12B, an opening/closing member 80 according to Example 2 will be described. FIG. 12A shows a state in which the leading end of the sheet reaches the photosensitive drum and FIG. 12B shows a state in which the rear end of the sheet is separated from the resist rollers pair.

The opening/closing member 80 according to Example 2 has a pair of rectangular film members 81, 82 (valve member). One film member 81 hangs downward inside of the discharge flow path 27 with an upper end fixed at a lower position from an upper end of the outer face of the supporting member 13b of the development unit 13. The other film member 82 hangs downward inside of the discharge flow path 27 with an upper end fixed at a lower position from an upper end of an outer face of the upper guiding plate 31 of the guiding part 6. Lower end portions of both film members 81, 82 are loosely brought into contact with each other by elasticity of the film member or friction. As a material for the film members 81, 82, a silicon film can be used.

In this opening/closing member 80, as shown in FIG. 12A, the airflow F4 generated in the photosensitive drum-side space S2 by abutting the leading end of the sheet P with the surface of the photosensitive drum 11 reaches the upper opening of the discharge flow path 27 and then is not introduced into the development nip 17 but the discharge flow path 27 as described above. Afterwards, the airflow enters from a gap between the upper end portions of both film members 81, 82 of the opening/closing member 80 and applies a pressure so as to open the lower end portions of both film members 81, 82 coming into contact with each other Then, the lower end portions of both film members 81, 82 are separated each other. Through the gap between both film members 81, 82, the airflow F4 flows downward through the discharge flow path 27. After the airflow F4 has passed, the lower end portions of the film members 81, 82 are loosely brought into contact with each other again by an elastic force or an electrostatic force.

On the other hand, if the rear end of the sheet P hits the corner of the upper guiding plate 31 and then the airflow F1 is generated in the sheet feeding part-side space S1, this airflow flows toward the discharge flow path 27 through the space S4 between the resist roller opposing portion 31a of the upper guiding plate 31 and the left resist roller 5L. However, as shown in FIG. 12B, in the opening/closing member 80, a sufficient force such that the lower end portions of both film members 81, 82 are separated each other is not generated and thus the discharge flow path 27 is kept closed. That is, the generated airflow F1 does not enter the discharge flow path 27, and thus an airflow directing toward the surface of the photosensitive drum 11 is not generated.

In the opening/closing member 80 of Example 2, since the lower end portions of the film members 81, 82 are automatically opened by the airflow generated in the image carrier-side space S2, it is not required to provide a mechanism to drive the opening/closing member 80 so that the number of parts can be reduced and manufacturing cost can be also reduced.

Incidentally, as the opening/closing member 80, one film member can also be used. In this case, one end of the film member is turnably supported on one of the outer faces of the supporting member 13b of the development unit 13 or the upper guiding plate 31 of the guiding part 6. And, the other end of the film member is engagingly locked with the other outer face movably downward through the discharge flow path 27 and unmovably upward through the discharge flow path 27. In this manner, if airflow enters from the upper opening of the discharge flow path 27 (the side of photosensitive drum-side space S2), a pressure is applied to the outer face of the film member and then the engagingly locking of the other end of the film member is released. Then, the film member turns downward to open the discharge flow path 27. On the other hand, if airflow flows from the lower opening of the discharge flow path 27 (the side of sheet feeding part-side space S1), a pressure is applied to a lower face of the film member, and however, since the other end of the film member is prevented from moving upward, the film member is not turned upward and thus the discharge flow path 27 is not opened.

The embodiment was described in a case of applying the configuration of the present disclosure to the printer 1. On the other hand, in another embodiment, the configuration of the disclosure may be applied to another image forming apparatus, such as a copying machine, a facsimile or a multifunction peripheral, except for the printer 1.

While the present disclosure has been described with reference to the particular illustrative embodiments, it is not to be restricted by the embodiments. It is to be appreciated that those skilled in the art can change or modify the embodiments without departing from the scope and spirit of the present disclosure.

What is claimed is:

1. An image forming apparatus comprising:
a development unit configured to forma developing nip with an image carrier and develop an electrostatic latent image formed on the image carrier into a toner image at the developing nip;
a transferring device configured to transfer the toner image to a sheet fed from a sheet feeding part;
a guiding part having an upper guiding plate disposed on a side of the development unit and a lower guiding plate disposed on a side of the transferring device, in which the upper guiding plate and the lower guiding plate form a sheet conveying path extending from the sheet feeding part to the transferring device between the development unit and the transferring device;
a discharge flow path formed between the development unit and the guiding part and communicating with a sheet feeding part-side space where the sheet conveying path faces the sheet feeding part and an image carrier-side space where the sheet conveying path faces the image carrier; and
an airflow control mechanism configured to guide airflow generated in the sheet feeding part-side space when a rear end of the sheet is separated from the sheet feeding part in a direction spaced away from the developing nip.

2. The image forming apparatus according to claim 1, wherein the airflow control mechanism has an extended portion extending from the sheet feeding part side end of the upper guiding plate between the development unit and the sheet feeding part in a direction spaced away from the transferring device, and
an airflow control path is formed between the extended portion and the sheet feeding part such that the airflow generated in the sheet feeding part-side space when the rear end of the sheet is separated from the sheet feeding part is guided in the direction spaced away from the developing nip.

3. The image forming apparatus according to claim 2, wherein the upper guiding plate has an inside guiding part protruding toward the sheet conveying path and forming a space with the upper guiding plate and
air flow generated when the sheet comes into contact with the inside guiding part during passing through the sheet conveying path is introduced toward the airflow control path through the space between the inside guide part and the upper guiding plate.

4. The image forming apparatus according to claim 3, wherein the inside guiding part includes a plurality of protruding portions arranged in a sheet width direction crossing the sheet conveying direction.

5. The image forming apparatus according to claim 4, wherein the protruding portion is formed by bending a plate-shaped piece elongated in the conveying direction and having a predetermined width.

6. The image forming apparatus according to claim 4, wherein the protruding portion is a plate-shaped rib extending along the conveying direction.

7. The image forming apparatus according to claim 3, wherein the inside guiding part includes a plate-shaped member extending in a sheet width direction crossing the sheet conveying direction.

8. The image forming apparatus according to claim 1, wherein the airflow control mechanism includes an opening/closing member capable of opening/closing the discharge flow path, and
the opening/closing member is configured to open the discharge flow path so as to introduce airflow generated in the image carrier-side space when a leading end of the sheet comes into contact with the surface of the image carrier into the discharge flow path and to close the discharge flow path so as to prevent airflow generated in the sheet feeding part-side space when a rear end of the sheet is separated from the sheet feeding part from flowing through the discharge flow path.

9. The image forming apparatus according to claim 8, wherein the opening/closing member is a shutter member turnable between an open position in which the discharge flow path is opened and a closed position in which the discharge flow path is closed, and
the shutter member is operated based on a position of the sheet conveyed along the sheet conveying path so as to turn to the open position when the leading end of the sheet comes into contact with the surface of the image carrier and to turn to the closed position when the rear end of the sheet is separated from the sheet feeding part.

10. The image forming apparatus according to claim 8, wherein the opening/closing member is a valve member opened by airflow introduced in the discharge flow path from the image carrier-side space and closed by airflow introduced in the discharge flow path from the sheet feeding part-side space.

11. The image forming apparatus according to claim 8, wherein the development unit has a supporting member configured to support a development roller which supplies a toner to the image carrier, and
a total area of an opening between the supporting member and the image carrier is smaller than a total area of an opening between the upper guiding plate of the guiding part and the image carrier.

12. The image forming apparatus according to claim 11, wherein a total area of the discharge flow path is larger than a total area of an opening between the supporting member and the image carrier.
